(19) United States
(12) Patent Application Publication
(10) Pub. No.: US 2026/0088935 A1
(43) Pub. Date: Mar. 26, 2026

(54) PROTOCOL DATA UNIT SEQUENCE NUMBER SYNCHRONIZATION IN WIRELESS COMMUNICATIONS

(71) Applicant: QUALCOMM Incorporated, San Diego, CA (US)

(72) Inventors: Sitaramanjaneyulu KANAMARLAPUDI, San Diego, CA (US); Prasada Veera Reddy KADIRI, San Diego, CA (US); Umesh PHUYAL, San Diego, CA (US)

(21) Appl. No.: 18/892,146

(22) Filed: Sep. 20, 2024

(51) Int. Cl. H04L 1/1607; H04W 76/20; H04W 80/02

(52) U.S. Cl. CPC H04L 1/1642; H04W 76/20; H04W 80/02

(57) ABSTRACT

Methods, systems, and devices for wireless communications are described in which one or more network entities may transmit protocol data units (PDUs) that may include a set of bits that indicate a packet data convergence protocol (PDCP) window at a receiving user equipment (UE) may be reset. The set of bits may have a first value that indicates the PDCP window is to be set with a lower bound, or left edge, that corresponds to a sequence number (SNs) indicated in the PDU. The UE may thus reset the PDCP window and buffer the received PDU for a radio bearer, without waiting for SNs to be within a prior PDCP window. The set of bits may have a second value that indicates the PDCP window is to be reset after a configured time period.

### FIELD OF TECHNOLOGY

The following relates to wireless communications, including protocol data unit sequence number synchronization in wireless communications.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include receiving a first packet data convergence protocol (PDCP) protocol data unit (PDU) that includes a set of bits, a first sequence number, and data, setting one or more parameters associated with a PDCP window based on a value of the set of bits and the first sequence number, where the PDCP window indicates a range of sequence numbers that are to be stored at the UE for reordering of received PDCP PDUs, and storing the first PDCP PDU in a buffer with one or more other PDCP PDUs based on the first Sequence number being within the PDCP window for PDCP PDU reordering.

A UE for wireless communications is described. The UE may include one or more memories storing processor executable code, and one or more processors coupled with the one or more memories. The one or more processors may individually or collectively be operable to execute the code to cause the UE to receive a first PDCP PDU that includes a set of bits, a first sequence number, and data, set one or more parameters associated with a PDCP window based on a value of the set of bits and the first sequence number, where the PDCP window indicates a range of sequence numbers that are to be stored at the UE for reordering of received PDCP PDUs, and store the first PDCP PDU in a buffer with one or more other PDCP PDUs based on the first Sequence number being within the PDCP window for PDCP PDU reordering.

Another UE for wireless communications is described. The UE may include means for receiving a first PDCP PDU that includes a set of bits, a first sequence number, and data, means for setting one or more parameters associated with a PDCP window based on a value of the set of bits and the first sequence number, where the PDCP window indicates a range of sequence numbers that are to be stored at the UE for reordering of received PDCP PDUs, and means for storing the first PDCP PDU in a buffer with one or more other PDCP PDUs based on the first Sequence number being within the PDCP window for PDCP PDU reordering.

A non-transitory computer-readable medium storing code for wireless communications is described. The code may include instructions executable by one or more processors to receive a first PDCP PDU that includes a set of bits, a first sequence number, and data, set one or more parameters associated with a PDCP window based on a value of the set of bits and the first sequence number, where the PDCP window indicates a range of sequence numbers that are to be stored at the UE for reordering of received PDCP PDUs, and store the first PDCP PDU in a buffer with one or more other PDCP PDUs based on the first Sequence number being within the PDCP window for PDCP PDU reordering.

In some examples of the method, UEs, and non-transitory computer-readable medium described herein, setting the one or more parameters associated with the PDCP window may include operations, features, means, or instructions for setting a lower bound of the range of sequence numbers as the first sequence number. Some examples of the method, UEs, and non-transitory computer-readable medium described herein may further include operations, features, means, or instructions for applying, based on the set of bits having a first value of two or more values, the one or more parameters associated with the PDCP window upon receipt of the set of bits. Some examples of the method, UEs, and non-transitory computer-readable medium described herein may further include operations, features, means, or instructions for applying, based on the set of bits having a second value of two or more values, the one or more parameters associated with the PDCP window after expiration of a time period. In some examples of the method, UEs, and non-transitory computer-readable medium described herein, the time period corresponds to a duration of a configured timer associated with the set of bits or a portion a duration of a reordering timer associated with the PDCP window.

In some examples of the method, UEs, and non-transitory computer-readable medium described herein, the one or more parameters associated with a PDCP window may be applied per radio bearer of a set of radio bearers configured at the UE. In some examples of the method, UEs, and non-transitory computer-readable medium described herein, the one or more parameters associated with the PDCP window may be selected from a set of PDCP parameters configured per radio bearer of the set of radio bearers, and where the set of PDCP parameters may be indicated by one or more of radio resource control (RRC) signaling or a medium access control (MAC) control element. In some examples of the method, UEs, and non-transitory computer-readable medium described herein, the one or more parameters associated with the PDCP window may be configured during configuration of each radio bearer, or may be based on a service that is associated with each radio bearer.

In some examples of the method, UEs, and non-transitory computer-readable medium described herein, the value of the set of bits may be based on traffic characteristics associated with the first PDCP PDU. In some examples of the method, UEs, and non-transitory computer-readable medium described herein, the value of the set of bits may be based on whether the first PDCP PDU includes data from a first data flow of two or more data flows.

Some examples of the method, UEs, and non-transitory computer-readable medium described herein may further include operations, features, means, or instructions for enabling the setting of the one or more parameters associated with the PDCP window based on one or more of an estimated block error rate of communications at the UE, a characteristic of a serving cell of the UE, a type of network used for communications at the UE, or a frequency band used for communications at the UE. In some examples of the method, UEs, and non-transitory computer-readable medium described herein, the set of bits may be included in a subset of bits of the PDCP PDU subsequent to a data or control indication bit and prior to the first sequence number in the PDCP PDU.

A method for wireless communications by a network entity is described. The method may include setting one or more parameters associated with a PDCP window for a UE, where the PDCP window indicates a range of sequence numbers that are to be stored at the UE for reordering of received PDCP PDUs and transmitting a first PDCP PDU to the UE that includes a set of bits, a first sequence number, and data, where a value of the set of bits indicates the one or more parameters associated with the PDCP window and that the UE is to store the first PDCP PDU in a buffer with one or more other PDCP PDUs based on the first sequence number being within the PDCP window for PDCP PDU reordering.

A network entity for wireless communications is described. The network entity may include one or more memories storing processor executable code, and one or more processors coupled with the one or more memories. The one or more processors may individually or collectively be operable to execute the code to cause the network entity to set one or more parameters associated with a PDCP window for a UE, where the PDCP window indicates a range of sequence numbers that are to be stored at the UE for reordering of received PDCP PDUs and transmit a first PDCP PDU to the UE that includes a set of bits, a first sequence number, and data, where a value of the set of bits indicates the one or more parameters associated with the PDCP window and that the UE is to store the first PDCP PDU in a buffer with one or more other PDCP PDUs based on the first sequence number being within the PDCP window for PDCP PDU reordering.

Another network entity for wireless communications is described. The network entity may include means for setting one or more parameters associated with a PDCP window for a UE, where the PDCP window indicates a range of sequence numbers that are to be stored at the UE for reordering of received PDCP PDUs and means for transmitting a first PDCP PDU to the UE that includes a set of bits, a first sequence number, and data, where a value of the set of bits indicates the one or more parameters associated with the PDCP window and that the UE is to store the first PDCP PDU in a buffer with one or more other PDCP PDUs based on the first sequence number being within the PDCP window for PDCP PDU reordering.

A non-transitory computer-readable medium storing code for wireless communications is described. The code may include instructions executable by one or more processors to set one or more parameters associated with a PDCP window for a UE, where the PDCP window indicates a range of sequence numbers that are to be stored at the UE for reordering of received PDCP PDUs and transmit a first PDCP PDU to the UE that includes a set of bits, a first sequence number, and data, where a value of the set of bits indicates the one or more parameters associated with the PDCP window and that the UE is to store the first PDCP PDU in a buffer with one or more other PDCP PDUs based on the first sequence number being within the PDCP window for PDCP PDU reordering.

In some examples of the method, network entities, and non-transitory computer-readable medium described herein, setting the one or more parameters associated with the PDCP window may include operations, features, means, or instructions for setting a lower bound of the range of sequence numbers as the first sequence number. In some examples of the method, network entities, and non-transitory computer-readable medium described herein, a first value of the set of bits indicates that the UE is to apply the one or more parameters associated with the PDCP window upon receipt of the set of bits. In some examples of the method, network entities, and non-transitory computer-readable medium described herein, a second value of the set of bits indicates that the UE is to apply the one or more parameters associated with the PDCP window after expiration of a time period. In some examples of the method, network entities, and non-transitory computer-readable medium described herein, the time period corresponds to a duration of a configured timer associated with the set of bits or a portion a duration of a reordering timer associated with the PDCP window.

In some examples of the method, network entities, and non-transitory computer-readable medium described herein, the one or more parameters associated with a PDCP window may be applied per radio bearer of a set of radio bearers configured at the UE. In some examples of the method, network entities, and non-transitory computer-readable medium described herein, the one or more parameters associated with the PDCP window may be selected from a set of PDCP parameters configured per radio bearer of the set of radio bearers, and where the set of PDCP parameters may be indicated by one or more of RRC signaling or a MAC control element. In some examples of the method, network entities, and non-transitory computer-readable medium described herein, the one or more parameters associated with the PDCP window may be configured during configuration of each radio bearer, or may be based on a service that is associated with each radio bearer.

In some examples of the method, network entities, and non-transitory computer-readable medium described herein, the value of the set of bits may be based on traffic characteristics associated with the first PDCP PDU. In some examples of the method, network entities, and non-transitory computer-readable medium described herein, the value of the set of bits may be based on whether the first PDCP PDU includes data from a first data flow of two or more data flows.

Some examples of the method, network entities, and non-transitory computer-readable medium described herein may further include operations, features, means, or instructions for configuring the UE to enable modification one or more parameters associated with the PDCP window based on one or more of an estimated block error rate of communications at the UE, a characteristic of a serving cell of the UE, a type of network used for communications at the UE, or a frequency band used for communications at the UE. In some examples of the method, network entities, and non-transitory computer-readable medium described herein, the set of bits may be included in a subset of bits of the PDCP PDU subsequent to a data or control indication bit and prior to the first sequence number in the PDCP PDU.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIGS. 1 through 3 show examples of wireless communications systems that supports protocol data unit sequence number synchronization in wireless communications in accordance with one or more aspects of the present disclosure.

FIG. 4 shows an example of a process flow that supports protocol data unit sequence number synchronization in wireless communications in accordance with one or more aspects of the present disclosure.

FIGS. 5 and 6 show block diagrams of devices that support protocol data unit sequence number synchronization in wireless communications in accordance with one or more aspects of the present disclosure.

FIG. 7 shows a block diagram of a communications manager that supports protocol data unit sequence number synchronization in wireless communications in accordance with one or more aspects of the present disclosure.

FIG. 8 shows a diagram of a system including a device that supports protocol data unit sequence number synchronization in wireless communications in accordance with one or more aspects of the present disclosure.

FIGS. 9 and 10 show block diagrams of devices that support protocol data unit sequence number synchronization in wireless communications in accordance with one or more aspects of the present disclosure.

FIG. 11 shows a block diagram of a communications manager that supports protocol data unit sequence number synchronization in wireless communications in accordance with one or more aspects of the present disclosure.

FIG. 12 shows a diagram of a system including a device that supports protocol data unit sequence number synchronization in wireless communications in accordance with one or more aspects of the present disclosure.

FIGS. 13 through 16 show flowcharts illustrating methods that support protocol data unit sequence number synchronization in wireless communications in accordance with one or more aspects of the present disclosure.

### DETAILED DESCRIPTION

In some wireless communications systems, a user equipment (UE) may receive packet data convergence protocol (PDCP) protocol data units (PDUs) and assemble communicated data from data included in the PDUs. In some cases, a transmission may fail, and one or more PDUs may need to be retransmitted. In order to properly assemble the communicated data, received PDUs may be ordered according to a sequence number (SN) that is included in the PDUs, which may allow retransmitted PDUs to be placed in order with other PDUs. In some cases, a radio link control (RLC) entity at the UE may manage ordering and reordering of PDCP PDUs. In unicast or point-to-point (PTP) operation, both a transmitting network entity and a receiving UE may establish and configure RLC entities with PDCP state variables that are initialized in accordance with established PDCP procedures, which include a PDCP window that provides a range of SNs that may be buffered at the UE. In the event that a PDU has a SN that is outside of the PDCP window, the UE may discard the PDU as being out-of-window. As PDUs are received and processed, the PDCP window may slide as new PDCP SNs are received. In some cases, a PDCP reordering timer may be initiated when an out-of-order SN is received, and a packet may be discarded when other PDUs with prior/subsequent SNs are not received when the reordering timer expires.

However, in some cases, the transmitting network entity and the receiving UE may not be able to initialize a PDCP window when the RLC entities are configured. For example, in some multicast-broadcast service (MBS) procedures, a UE may join a session in which ongoing communications are already present, and an initial state variable value associated with the PDCP window may not be correct. In such situations, an actual MBS PDU SN may not be within a configured PDCP window at the UE, which may result in the UE having to wait a relatively long time before receiving any PDUs that do have SNs within the PDCP window, which can in turn result in relatively long latency. In other examples, a UE may support an extended reality (XR) service that has relatively low delay targets, and retransmitted PDUs that are not received within a particular time may result in a PDCP window stall that results in multiple PDUs exceeding the delay targets. In accordance with various techniques discussed herein, a network entity may signal to a UE that the UE can reset its PDCP window without having to wait for a PDU SN that is within a previously set window.

In some aspects, a PDU may include a set of bits that may be used to indicate the PDCP window may be reset. In some examples the set of bits may be one or more bits of PDCP data PDUs that are reserved bits located at a beginning of the PDU (e.g., after a data/control indication bit and prior to the PDCP SN that is included in the PDU. For example, in accordance with established PDCP procedures, when a 12 bit PDCP SN is used, there are three reserved bits, and when an 18 bit PDCP SN is used, there are five reserved bits, at the beginning of a PDU. In some aspects, the set of bits may be selected from the reserved bits, and a non-zero value of the bits may indicate that the UE can reset its PDCP window based on the SN of the PDCP PDU. In some examples, the set to bits may include two bits that may be set to a first value that indicates the PDCP window is to be set with a lower bound, or left edge, that corresponds to the PDCP SN indicated in the PDU. The UE may thus reset the PDCP window and buffer the received PDU for a radio bearer, without delay associated with waiting for SNs to be within the prior PDCP window. In some examples, the set of bits may include two bits that may be set to a second value that indicates the PDCP window is to be set with a lower bound, or left edge, that corresponds to the PDCP SN indicated in the PDU after a configured time period (e.g., that is separately configured such as via radio resource control (RRC) signaling, or that is a fraction of a reordering timer). Further, in some cases, a third value of the set of bits (e.g., a zero value) may indicate that there is to be no adjustment of the PDCP window at the UE.

Such techniques may allow a PDCP window to be reset at a UE with a reduced latency that may be beneficial in multiple situations, such as for MBS communications when a UE joins a service with communications in process, when a UE resumes from an idle mode and is not aware of a current PDCP SN status, when a UE is supporting XR communications and can discard PDUs that are beyond a delay target, or when a UE is supporting latency sensitive communications (e.g., real-time voice communications or a ultra-reliable low latency communications (URLLC) service) where higher delays can result in high packet jitter. In such situations, a reset of the PDCP window may provide for enhanced communications and improved user experience.

Aspects of the disclosure are initially described in the context of wireless communications systems. Aspects of the disclosure are further illustrated by and described with reference to process flows, apparatus diagrams, system diagrams, and flowcharts that relate to protocol data unit sequence number synchronization in wireless communications.

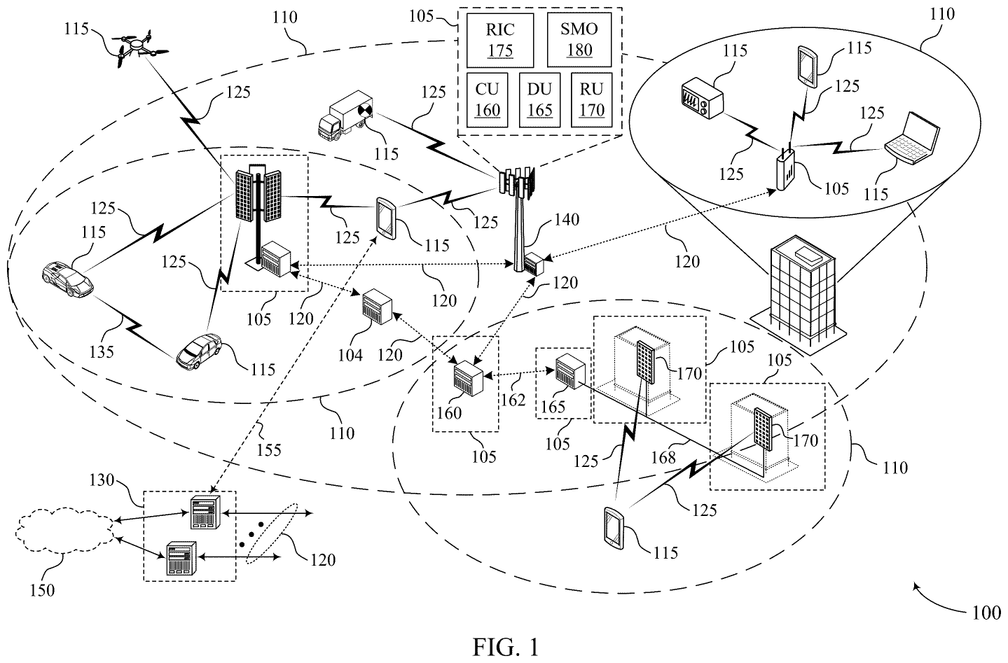

FIG. 1 shows an example of a wireless communications system 100 that supports protocol data unit sequence number synchronization in wireless communications in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support protocol data unit sequence number synchronization in wireless communications as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

In some aspects, one or more network entities 105 may transmit PDUs that may include a set of bits that indicate a PDCP window at one or more receiving UEs 115 may be reset. In some examples, the set to bits may include two bits that may have a first value that indicates the PDCP window is to be set with a lower bound, or left edge, that corresponds to the PDCP SN indicated in the PDU. A UE 115 may thus reset the PDCP window and buffer the received PDU for a radio bearer, without delay associated with waiting for SNs to be within the prior PDCP window. In some examples, the set of bits may be set to a second value that indicates the PDCP window is to be set with a lower bound that corresponds to the PDCP SN indicated in the PDU after a configured time period (e.g., that is separately configured such as via RRC signaling, or that is a fraction of a reordering timer). Further, in some cases, a third value of the set of bits (e.g., a zero value) may indicate that there is to be no adjustment of the PDCP window at the UE.

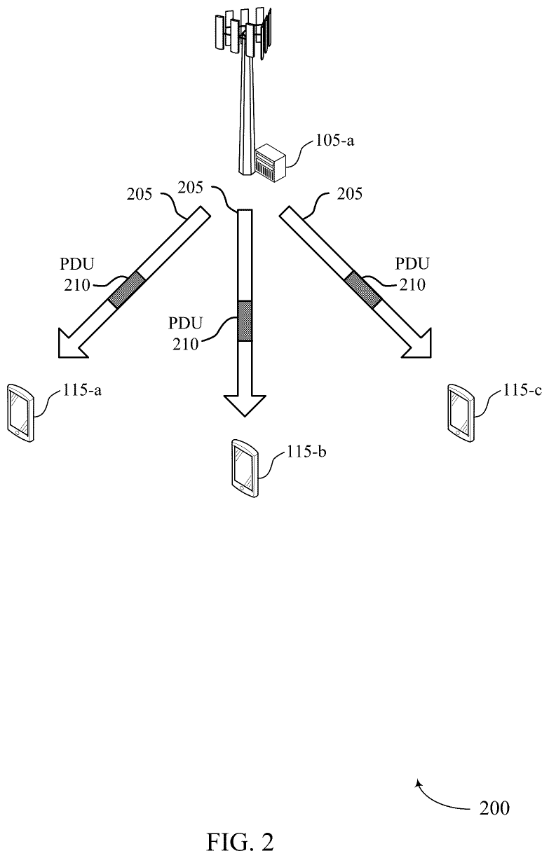

FIG. 2 shows an example of a wireless communications system 200 that supports protocol data unit sequence number synchronization in wireless communications in accordance with one or more aspects of the present disclosure. The wireless communications system 200 may implement or be implemented by aspects of the wireless communications system 100 as described herein with reference to FIG. 1. For example, the wireless communications system 200 may include a network entity 105-a, and multiple UEs 115 that may use a MBS service of the network entity 105-a, including a first UE 115-a, a second UE 115-b, and a third UE 115-c. The UEs 115 and network entity 105-a may be examples of UEs 115 and network entities 105 as described herein with reference to FIG. 1. The wireless communications system 200 may support 3G, 4G, 5G, 6G, or radio access technologies beyond 6G.

The UEs 115 and the network entity 105-a may perform wireless communication (e.g., one or more of receiving, obtaining, transmitting, or outputting one or more of control information, configuration information, or data) via a communication links 205, which may be examples of communications links 125 as described herein with reference to FIG. 1. In this example, the UEs 115 may have joined a MBS service of the network entity 105-a, and the network entity 105-a may transmit PDUs 210 to the UEs 115, where each UE 115 receives a same PDU. As discussed herein, in some cases a UE 115, such as first UE 115-a, may join a MBS service after the service has been initiated and multiple PDUs may have already been transmitted with associated SNs. When the first UE 115-a joins the service, it may have a MBS radio bearer (MRB) with a PDCP window configured with initial values that do not represent a current state of the MBS transmissions and PDUs 210. For example, the first UE 115-a may set its PDCP window to a value associated with a non-MRB initial value which is zero. When the received MRB PDCP SN in PDU 210 is not zero, without an indication to reset the PDCP window provided in the PDU 210, there can be three possible scenarios. First, the PDCP SN of the PDU 210 can be just below the lower edge of the first UE 115-a PDCP window, and the first UE 115-a might discard the PDU 210 as part of an out-of-window PDCP condition. Second, the PDCP SN of the PDU 210 can be in the middle of the PDCP window, which may trigger a reordering timer (e.g., a Treordering timer). Third, the PDCP SN can be above the right edge of the PDCP window, and the first UE 115-a may discard the PDU 210 as part of the out-of-window PDCP condition. For the first and third scenarios it might take a long time for the first UE 115-a to be in-sync from a PDCP SN perspective, and until then there may be complete packet drop at the PDCP level, which may interrupt the user service even after UE is able to connect to the multicast service and decode successfully. For the second scenario, packets are delayed until the timer (e.g., Treordering) expiry and afterwards service will continue.

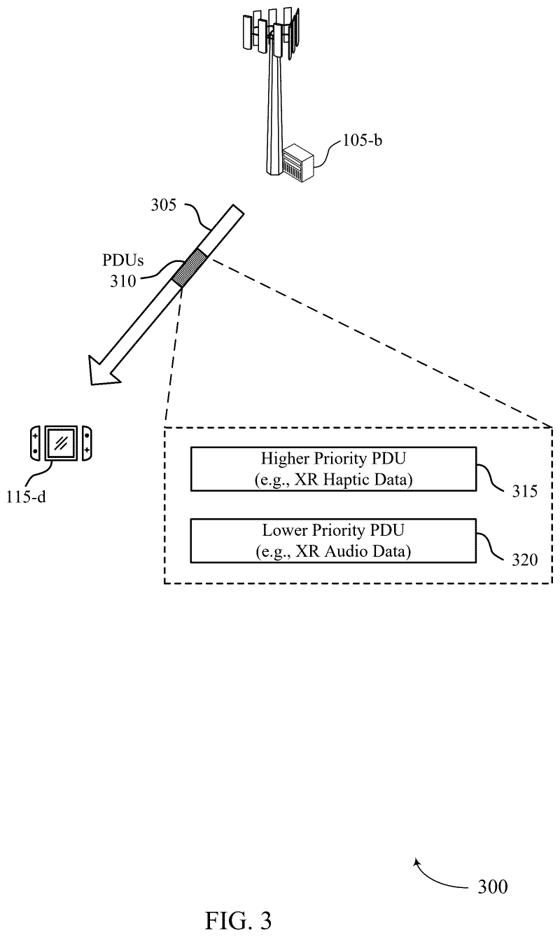

In other situations, the first UE 115-a may be in a steady state of operation (e.g., in the middle of the ongoing session), and there may be instances where packet loss can be seen with changing radio conditions (e.g., non-zero HARQ block error rate (BLER)) across multiple users in the MBS cell. Even with an increased number of duplication of packets at the PDCP level, with the non-zero BLER packets can be lost, which may result in added latency at the first UE 115-a. In other aspects, one or more UEs 115 may operate using different services that may be delay sensitive, such as XR services. An example of an XR deployment is illustrated in FIG. 3.

In accordance with various aspects, synchronization may be provided for PDCP SN window management in-band with a PDU 210 transmission. In some aspects, a PDCP Data PDU 210 may include a set of bits that indicate that a PDCP window is to be reset at a UE 115-. In some cases, the set of bits may include one or more bits of a group of reserved bits in accordance with existing PDCP specifications, such as three reserved bits in 12-bit SN PDUs and 5 reserved bits in 18-bit SN PDUs. In some aspects, one or two of the reserved bits can be modified to indicate a new definition of the received PDCP SN. For example, whenever this PDCP SN is received with non-zero values for the S1 and S2 bits illustrated in the exemplary PDCP format of Table 1, a receiving UE 115 may assume this PDU SN as lower edge of the PDCP window (e.g., by setting a RX_NEXT to this value and delivering any packets which fall below the RX_NEXT to upper layers to ensure the window movement is smooth). It is noted that the example of Table 1 is for a PDU with a 12-bit SN, and such bits may also be included for PDUs with a 18-bit SN. Further, the S1/S2 bit(s) could be based on other reserved bit(s) of a PDU, and could be applied to other packet formats with different PDCP SN length.

TABLE 1
PDCP format that includes a set of bits (S1/S2) to indicate PDCP
window reset - for PDCP Data PDU format with 12 bits PDCP SN.

| | | | | |
|---|---|---|---|---|
| D/C | R | S1 | S2 | PDCP SN |

PDCP SN (Cont)
Data
. . .
MAC-I (Optional)
MAC-I (Cont) (Optional)
MAC-I (Cont) (Optional)
MAC-I (Cont) (Optional)

In some aspects, two different options may be used to indicate how quickly a UE 115 resets its PDCP window based on the received PDU SN value. A first option is to reset the PDCP window immediately upon receipt of the PDCP SN, where the PDCP SN is set as a lower bound or left edge of the PDCP window. In some aspects, the first option is indicated by a first non-zero value of the set of bits (e.g., 0,1). A second option is to reset the PDCP window after some amount of time (e.g., a time period that is shorter than a reordering timer), where the PDCP SN is set as a lower bound or left edge of the PDCP window. In some aspects, the second option is indicated by a second non-zero value of the set of bits (e.g., 1,0). In some aspects, a new timer value for when to apply the reset PDCP window may be explicit, or may be a scaled version of the reordering timer (e.g., one-quarter or one-half of the timer Treordering). This timer value can be semi-statically configured during radio bearer configuration or specific to a service (e.g., a QOS or PDU session), and may be indicated through configuration signaling such as radio resource control (RRC) signaling, radio bearer configuration, a medium access control (MAC) control element, or any combinations thereof.

In some aspects, this mechanism of reserved bits indicating the PDCP window movement can be indicated through PDCP in-band signaling, or through a RLC PDU also. If done through a RLC PDU level, in some cases, an RLC acknowledge-mode (AM) window may be moved without waiting for retransmissions or unnecessarily triggering a radio link failure. Additionally, this mechanism may save bandwidth over the air, as the transmitter does not need to retransmit packets which are already past a delay budget, which may also improve radio resource management (RRM) aspects and power aspects (e.g., discontinuous reception (DRX), and the like) at a receiving UE 115.

Accordingly, PDCP window reset techniques as discussed may provide for enhanced MBS communications through relatively fast synchronization of PDCP variables between UEs 115 and the network entity 105-a. Further, in some cases the PDCP window reset may be indicated without additional RRC signaling or configurations. In other aspects, PDCP window reset techniques may be used for other services, such as delay sensitive services (e.g., real-time voice services or URLLC services) which may experience higher delays due to PDCP reordering timers (e.g., Treordering), and thus the described techniques may reduce such delays and reduce jitter. As discussed above, techniques provided herein may also be used for other types of services, such as XR services as illustrated in FIG. 3.

FIG. 3 shows an example of a wireless communications system 300 that supports protocol data unit sequence number synchronization in wireless communications in accordance with one or more aspects of the present disclosure. The wireless communications system 300 may implement or be implemented by aspects of the wireless communications systems 100 or 200 as described herein with reference to FIGS. 1 and 2. For example, the wireless communications system 300 may include a network entity 105-b, and a UE 115-d, which may be examples of UEs 115 and network entities 105 as described herein. The wireless communications system 300 may support 3G, 4G, 5G, 6G, or radio access technologies beyond 6G.

The UE 115-d and the network entity 105-b may perform wireless communication (e.g., one or more of receiving, obtaining, transmitting, or outputting one or more of control information, configuration information, or data) via a communication links 305, which may be examples of communications links 125 as described herein with reference to FIG. 1 or communication links 205 of FIG. 2. In this example, the UE 115-d may have joined a XR service in which multiple PDUs 310 are transmitted, and different PDUs packets may have different priorities. For example, higher priority PDUs 315 may include delay-sensitive data (e.g., XR haptic data), and lower priority PDUs 320 may include more delay-tolerant data (e.g., XR audio data).

In some cases, due to the latency and delay requirements of XR traffic, it is possible to lose some packets due to dynamic radio conditions in the network, which can lead to a PDCP SN out-of-sync state and may result in a stall of the PDCP window and decoding. For example, with multi-modality services in XR, some delay targets may be for less than 5 ms latency (e.g., for haptic traffic) result in a need for relatively quick movement of packets for specific traffic in PDCP. Further, in case of XR, as different PDU sets have different priorities and with practical PDU loss at the MAC/RLC level, whenever a priority PDU set is transmitted, the network entity 105-b may set the PDCP window reset indication bit(s) (e.g., the set of bits) to ensure that important traffic does not get stalled (e.g., due to large reordering time (Treordering)) or lost due to window matching issues. Described techniques also helps to bring relatively quick synchronization between the UE 115-d and the network entity 105-b for priority packet handling at PDCP, by providing that low priority packets may be discarded at the RLC level after some number of retransmissions due to validity of the traffic based on QOS requirements, such as delay budget, for that traffic.

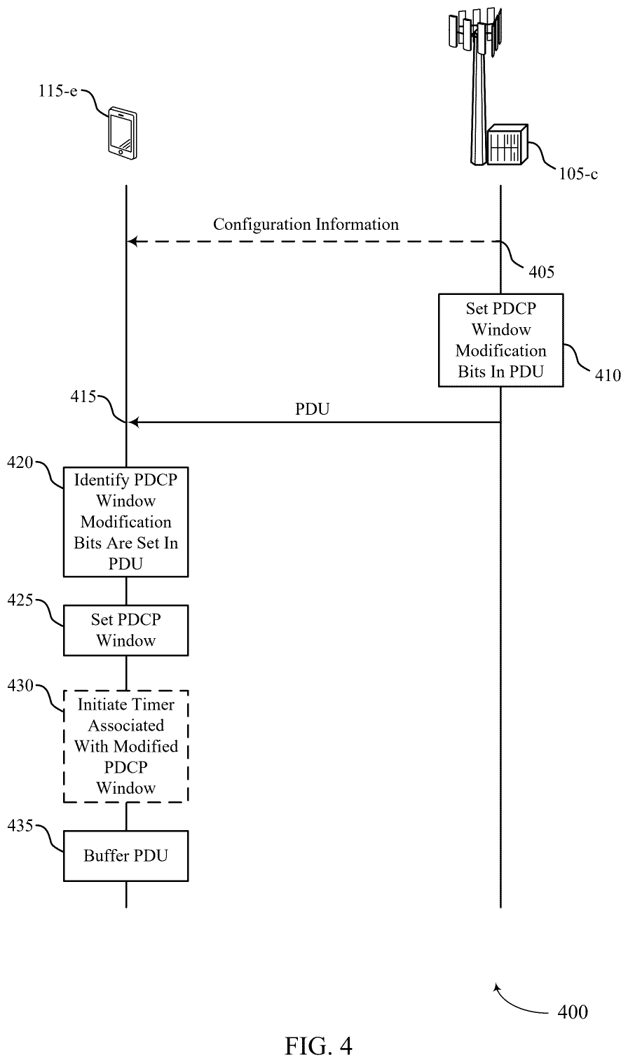

FIG. 4 shows an example of a process flow 400 that supports protocol data unit sequence number synchronization in wireless communications in accordance with one or more aspects of the present disclosure. The process flow 400 may include a network entity 105-c, and a UE 115-e, which may be examples of network entities and UEs as described with reference to FIGS. 1 through 3. The process flow 400 may be implemented by the network entity 105-c, and the UE 115-e where a PDCP window may be reset. Such techniques may provide for reduced latency and efficient communications with to the UE 115-e, which may thereby enhance overall network efficiency and user experience. In the following description of the process flow 400, the operations between the network entity 105-c, and the UE 115-e may be performed in a different order than the example order shown. Some operations may be omitted from the process flow 400, and other operations may be added to the process flow 400.

Optionally, at 405, the network entity 105-c may transmit, and the UE 115-e may receive, configuration information. The configuration information may configure the UE 115-e to perform PDCP window reset procedures based on a set of bits included in a PDU. In some examples, the configuration information may indicate a time duration for a timer, or a portion of a reordering timer, that is to be used when the reset PDCP window is implemented at some time subsequent to a receipt of a PDU with an indication to reset the PDCP window.

At 410, the network entity 105-c may determine to set the PDCP window modification bits in a PDU. In some cases, such a determination may be made when the UE 115-e has joined an MBS service that is already in progress, or when a packet delay budget of a service provides relatively low latency.

At 415, the network entity 105-c may transmit, and the UE 115-e may receive, a PDU. At 420, the UE 115-e may identify that the PDCP window modification bits are set in the PDU (e.g., the set of reserved bits in the PDU have a non-zero value). Based on such an identification, at 425, the UE 115-e may set the PDCP window in accordance with the PDCP modification. In some cases, the UE 115-e may set a lower bound, or left edge, of the PDCP window to be a PDCP SN that is included in the received PDU.

Optionally, at 430, the UE 115-e may initiate a timer associated with the modified PDCP window. The timer, as discussed herein, may be a timer that is separately configured at the UE 115-e, may be a portion of a reordering timer provided in a PDCP configuration, or any combinations thereof. At 435, the UE 115-e may buffer the received PDU in accordance with PDCP procedures.

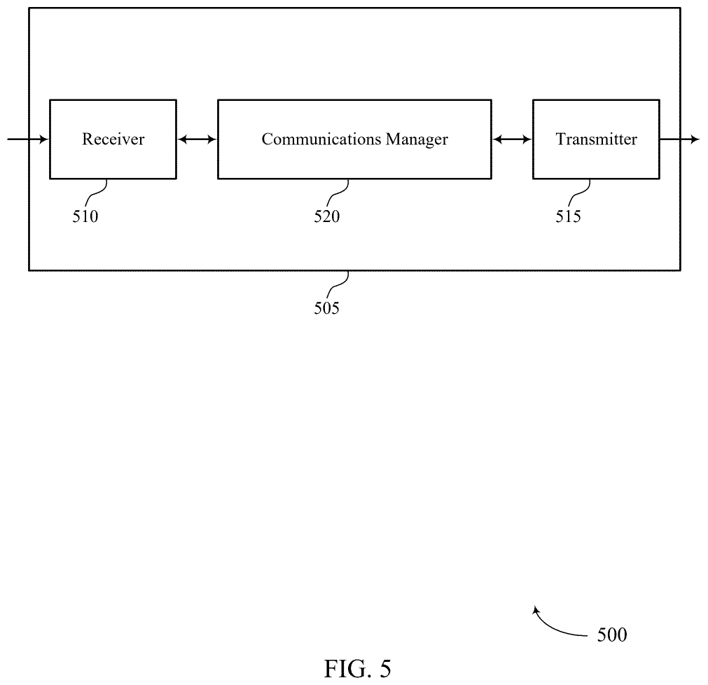

FIG. 5 shows a block diagram 500 of a device 505 that supports protocol data unit sequence number synchronization in wireless communications in accordance with one or more aspects of the present disclosure. The device 505 may be an example of aspects of a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to, individually or collectively, support or enable the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to protocol data unit sequence number synchronization in wireless communications). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to protocol data unit sequence number synchronization in wireless communications). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations or components thereof may be examples of means for performing various aspects of protocol data unit sequence number synchronization in wireless communications as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software or firmware) executed by at least one processor (e.g., referred to as a processor-executable code). If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. For example, the communications manager 520 is capable of, configured to, or operable to support a means for receiving a first packet data convergence protocol (PDCP) protocol data unit (PDU) that includes a set of bits, a first sequence number, and data. The communications manager 520 is capable of, configured to, or operable to support a means for setting one or more parameters associated with a PDCP window based on a value of the set of bits and the first sequence number, where the PDCP window indicates a range of sequence numbers that are to be stored at the UE for reordering of received PDCP PDUs. The communications manager 520 is capable of, configured to, or operable to support a means for storing the first PDCP PDU in a buffer with one or more other PDCP PDUs based on the first Sequence number being within the PDCP window for PDCP PDU reordering.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for PDCP window reset at a UE that may provide reduced latency for some communications, reduced jitter for delay-sensitive traffic, and reduced processing associated with PDU reordering.

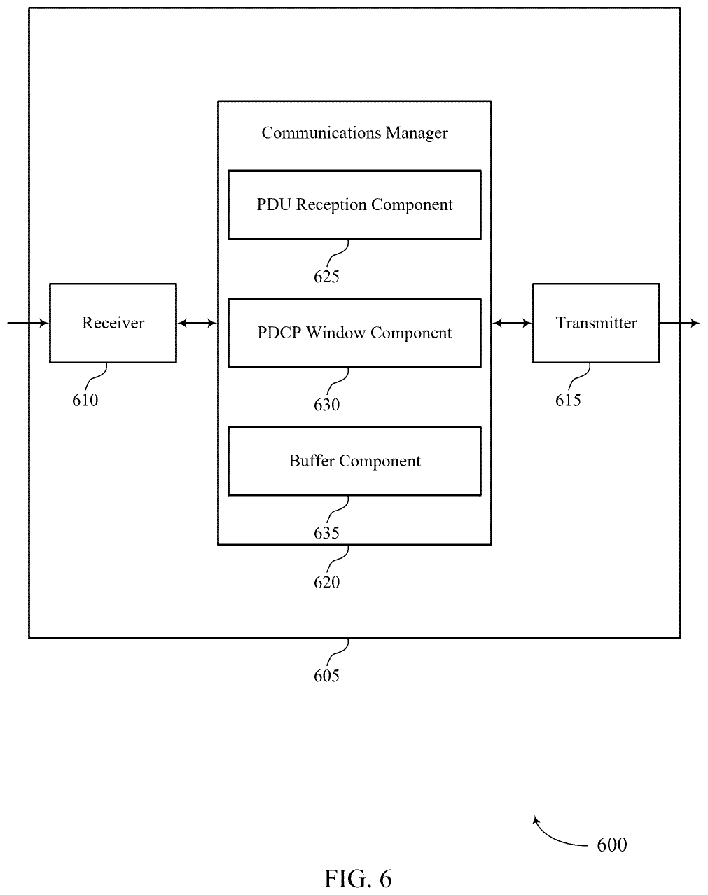

FIG. 6 shows a block diagram 600 of a device 605 that supports protocol data unit sequence number synchronization in wireless communications in accordance with one or more aspects of the present disclosure. The device 605 may be an example of aspects of a device 505 or a UE 115 as described herein. The device 605 may include a receiver 610, a transmitter 615, and a communications manager 620. The device 605, or one of more components of the device 605 (e.g., the receiver 610, the transmitter 615, the communications manager 620), may include at least one processor, which may be coupled with at least one memory, to support the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to protocol data unit sequence number synchronization in wireless communications). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to protocol data unit sequence number synchronization in wireless communications). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of protocol data unit sequence number synchronization in wireless communications as described herein. For example, the communications manager 620 may include a PDU reception component 625, a PDCP window component 630, a buffer component 635, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. The PDU reception component 625 is capable of, configured to, or operable to support a means for receiving a first packet data convergence protocol (PDCP) protocol data unit (PDU) that includes a set of bits, a first sequence number, and data. The PDCP window component 630 is capable of, configured to, or operable to support a means for setting one or more parameters associated with a PDCP window based on a value of the set of bits and the first sequence number, where the PDCP window indicates a range of sequence numbers that are to be stored at the UE for reordering of received PDCP PDUs. The buffer component 635 is capable of, configured to, or operable to support a means for storing the first PDCP PDU in a buffer with one or more other PDCP PDUs based on the first Sequence number being within the PDCP window for PDCP PDU reordering.

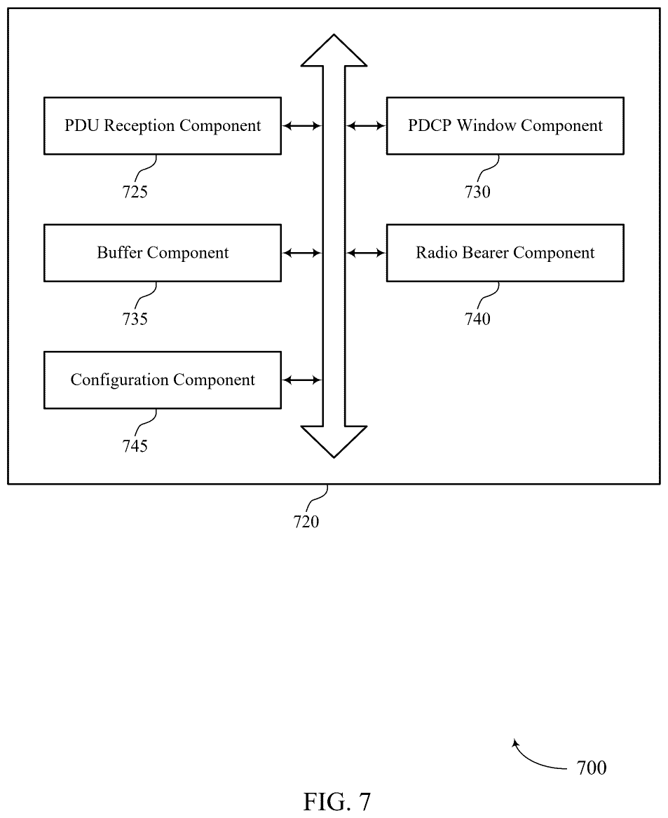

FIG. 7 shows a block diagram 700 of a communications manager 720 that supports protocol data unit sequence number synchronization in wireless communications in accordance with one or more aspects of the present disclosure. The communications manager 720 may be an example of aspects of a communications manager 520, a communications manager 620, or both, as described herein. The communications manager 720, or various components thereof, may be an example of means for performing various aspects of protocol data unit sequence number synchronization in wireless communications as described herein. For example, the communications manager 720 may include a PDU reception component 725, a PDCP window component 730, a buffer component 735, a radio bearer component 740, a configuration component 745, or any combination thereof. Each of these components, or components or subcomponents thereof (e.g., one or more processors, one or more memories), may communicate, directly or indirectly, with one another (e.g., via one or more buses).

The communications manager 720 may support wireless communications in accordance with examples as disclosed herein. The PDU reception component 725 is capable of, configured to, or operable to support a means for receiving a first packet data convergence protocol (PDCP) protocol data unit (PDU) that includes a set of bits, a first sequence number, and data. The PDCP window component 730 is capable of, configured to, or operable to support a means for setting one or more parameters associated with a PDCP window based on a value of the set of bits and the first sequence number, where the PDCP window indicates a range of sequence numbers that are to be stored at the UE for reordering of received PDCP PDUs. The buffer component 735 is capable of, configured to, or operable to support a means for storing the first PDCP PDU in a buffer with one or more other PDCP PDUs based on the first Sequence number being within the PDCP window for PDCP PDU reordering.

In some examples, to support setting the one or more parameters associated with the PDCP window, the PDCP window component 730 is capable of, configured to, or operable to support a means for setting a lower bound of the range of sequence numbers as the first sequence number. In some examples, the PDCP window component 730 is capable of, configured to, or operable to support a means for applying, based on the set of bits having a first value of two or more values, the one or more parameters associated with the PDCP window upon receipt of the set of bits.

In some examples, the PDCP window component 730 is capable of, configured to, or operable to support a means for applying, based on the set of bits having a second value of two or more values, the one or more parameters associated with the PDCP window after expiration of a time period. In some examples, the time period corresponds to a duration of a configured timer associated with the set of bits or a portion a duration of a reordering timer associated with the PDCP window.

In some examples, the one or more parameters associated with a PDCP window are applied per radio bearer of a set of radio bearers configured at the UE. In some examples, the one or more parameters associated with the PDCP window are selected from a set of PDCP parameters configured per radio bearer of the set of radio bearers, and where the set of PDCP parameters are indicated by one or more of RRC signaling or a medium access control (MAC) control element. In some examples, the one or more parameters associated with the PDCP window are configured during configuration of each radio bearer, or are based on a service that is associated with each radio bearer. In some examples, the value of the set of bits is based on traffic characteristics associated with the first PDCP PDU. In some examples, the value of the set of bits is based on whether the first PDCP PDU includes data from a first data flow of two or more data flows.

In some examples, the PDCP window component 730 is capable of, configured to, or operable to support a means for enabling the setting of the one or more parameters associated with the PDCP window based on one or more of an estimated block error rate of communications at the UE, a characteristic of a serving cell of the UE, a type of network used for communications at the UE, or a frequency band used for communications at the UE. In some examples, the set of bits are included in a subset of bits of the PDCP PDU subsequent to a data or control indication bit and prior to the first sequence number in the PDCP PDU.

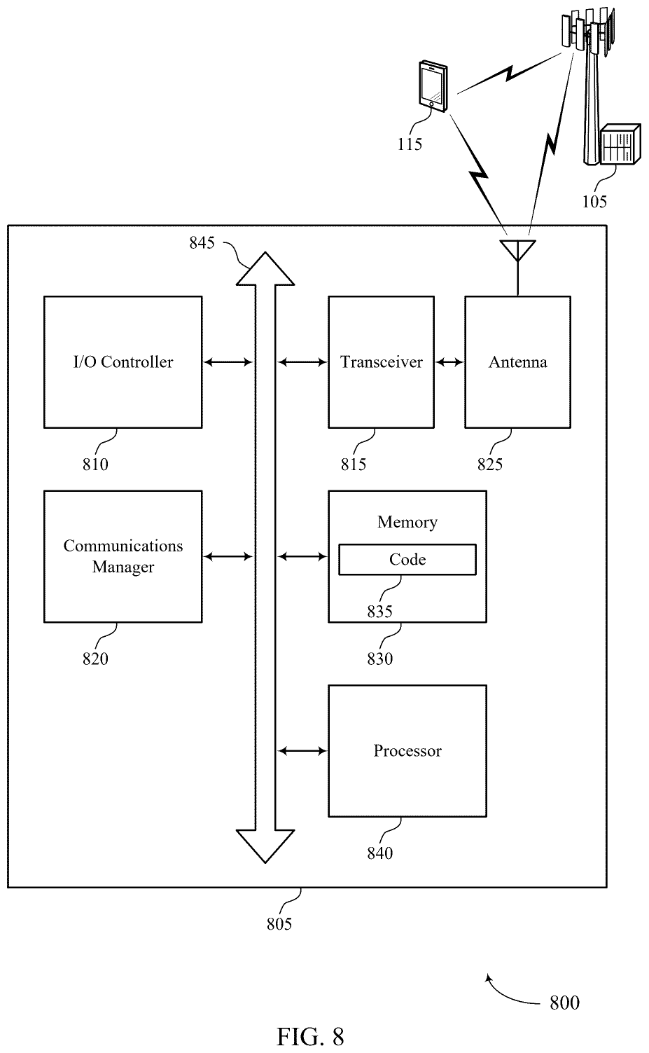

FIG. 8 shows a diagram of a system 800 including a device 805 that supports protocol data unit sequence number synchronization in wireless communications in accordance with one or more aspects of the present disclosure. The device 805 may be an example of or include components of a device 505, a device 605, or a UE 115 as described herein. The device 805 may communicate (e.g., wirelessly) with one or more other devices (e.g., network entities 105, UEs 115, or a combination thereof). The device 805 may include components for bi-directional voice and data communications including components for transmitting and receiving communications, such as a communications manager 820, an input/output (I/O) controller, such as an I/O controller 810, a transceiver 815, one or more antennas 825, at least one memory 830, code 835, and at least one processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of one or more processors, such as the at least one processor 840. In some cases, a user may interact with the device 805 via the I/O controller 810 or via hardware components controlled by the I/O controller 810.

In some cases, the device 805 may include a single antenna. However, in some other cases, the device 805 may have more than one antenna, which may be capable of concurrently transmitting or receiving multiple wireless transmissions. The transceiver 815 may communicate bi-directionally via the one or more antennas 825 using wired or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The at least one memory 830 may include random access memory (RAM) and read-only memory (ROM). The at least one memory 830 may store computer-readable, computer-executable, or processor-executable code, such as the code 835. The code 835 may include instructions that, when executed by the at least one processor 840, cause the device 805 to perform various functions described herein. The code 835 may be stored in a non-transitory computer-readable medium such as system memory or another type of memory. In some cases, the code 835 may not be directly executable by the at least one processor 840 but may cause a computer (e.g., when compiled and executed) to perform functions described herein. In some cases, the at least one memory 830 may include, among other things, a basic I/O system (BIOS) which may control basic hardware or software operation such as the interaction with peripheral components or devices.

The at least one processor 840 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 840 may be configured to operate a memory array using a memory controller. In some other cases, a memory controller may be integrated into the at least one processor 840. The at least one processor 840 may be configured to execute computer-readable instructions stored in a memory (e.g., the at least one memory 830) to cause the device 805 to perform various functions (e.g., functions or tasks supporting protocol data unit sequence number synchronization in wireless communications). For example, the device 805 or a component of the device 805 may include at least one processor 840 and at least one memory 830 coupled with or to the at least one processor 840, the at least one processor 840 and the at least one memory 830 configured to perform various functions described herein.

In some examples, the at least one processor 840 may include multiple processors and the at least one memory 830 may include multiple memories. One or more of the multiple processors may be coupled with one or more of the multiple memories, which may, individually or collectively, be configured to perform various functions described herein. In some examples, the at least one processor 840 may be a component of a processing system, which may refer to a system (such as a series) of machines, circuitry (including, for example, one or both of processor circuitry (which may include the at least one processor 840) and memory circuitry (which may include the at least one memory 830)), or components, that receives or obtains inputs and processes the inputs to produce, generate, or obtain a set of outputs. The processing system may be configured to perform one or more of the functions described herein. For example, the at least one processor 840 or a processing system including the at least one processor 840 may be configured to, configurable to, or operable to cause the device 805 to perform one or more of the functions described herein. Further, as described herein, being “configured to,” being “configurable to,” and being “operable to” may be used interchangeably and may be associated with a capability, when executing code 835 (e.g., processor-executable code) stored in the at least one memory 830 or otherwise, to perform one or more of the functions described herein.

The communications manager 820 may support wireless communications in accordance with examples as disclosed herein. For example, the communications manager 820 is capable of, configured to, or operable to support a means for receiving a first packet data convergence protocol (PDCP) protocol data unit (PDU) that includes a set of bits, a first sequence number, and data. The communications manager 820 is capable of, configured to, or operable to support a means for setting one or more parameters associated with a PDCP window based on a value of the set of bits and the first sequence number, where the PDCP window indicates a range of sequence numbers that are to be stored at the UE for reordering of received PDCP PDUs. The communications manager 820 is capable of, configured to, or operable to support a means for storing the first PDCP PDU in a buffer with one or more other PDCP PDUs based on the first Sequence number being within the PDCP window for PDCP PDU reordering.

By including or configuring the communications manager 820 in accordance with examples as described herein, the device 805 may support techniques for PDCP window reset at a UE that may provide reduced latency for communications, reduced jitter for delay-sensitive traffic, and improved user experience.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the at least one processor 840, the at least one memory 830, the code 835, or any combination thereof. For example, the code 835 may include instructions executable by the at least one processor 840 to cause the device 805 to perform various aspects of protocol data unit sequence number synchronization in wireless communications as described herein, or the at least one processor 840 and the at least one memory 830 may be otherwise configured to, individually or collectively, perform or support such operations.

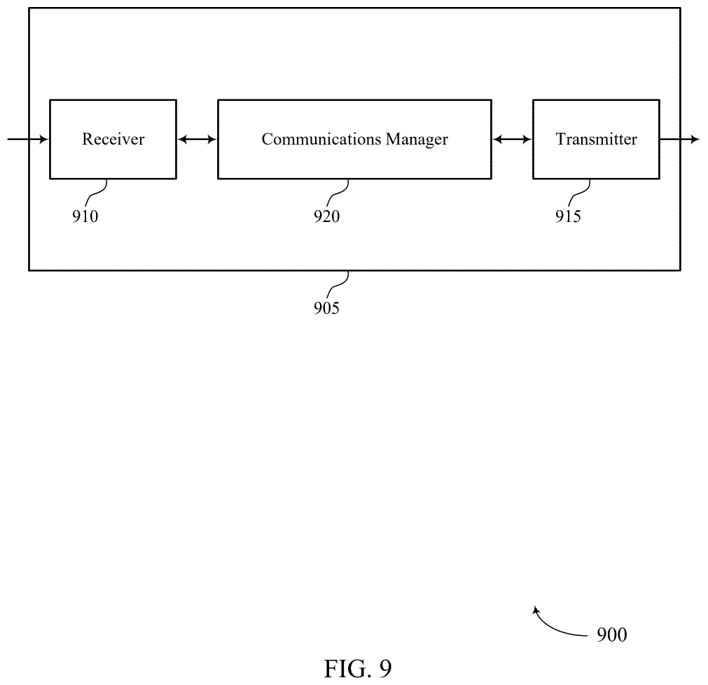

FIG. 9 shows a block diagram 900 of a device 905 that supports protocol data unit sequence number synchronization in wireless communications in accordance with one or more aspects of the present disclosure. The device 905 may be an example of aspects of a network entity 105 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to, individually or collectively, support or enable the described techniques. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The communications manager 920, the receiver 910, the transmitter 915, or various combinations or components thereof may be examples of means for performing various aspects of protocol data unit sequence number synchronization in wireless communications as described herein. For example, the communications manager 920, the receiver 910, the transmitter 915, or various combinations or components thereof may be capable of performing one or more of the functions described herein.

In some examples, the communications manager 920, the receiver 910, the transmitter 915, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 920, the receiver 910, the transmitter 915, or various combinations or components thereof may be implemented in code (e.g., as communications management software or firmware) executed by at least one processor (e.g., referred to as a processor-executable code). If implemented in code executed by at least one processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. For example, the communications manager 920 is capable of, configured to, or operable to support a means for setting one or more parameters associated with a packet data convergence protocol (PDCP) window for a UE, where the PDCP window indicates a range of sequence numbers that are to be stored at the UE for reordering of received PDCP protocol data units (PDUs). The communications manager 920 is capable of, configured to, or operable to support a means for transmitting a first PDCP PDU to the UE that includes a set of bits, a first sequence number, and data, where a value of the set of bits indicates the one or more parameters associated with the PDCP window and that the UE is to store the first PDCP PDU in a buffer with one or more other PDCP PDUs based on the first sequence number being within the PDCP window for PDCP PDU reordering.

By including or configuring the communications manager 920 in accordance with examples as described herein, the device 905 (e.g., at least one processor controlling or otherwise coupled with the receiver 910, the transmitter 915, the communications manager 920, or a combination thereof) may support techniques for PDCP window reset at a UE that may provide reduced latency for some communications, reduced jitter for delay-sensitive traffic, and reduced processing associated with PDU reordering.

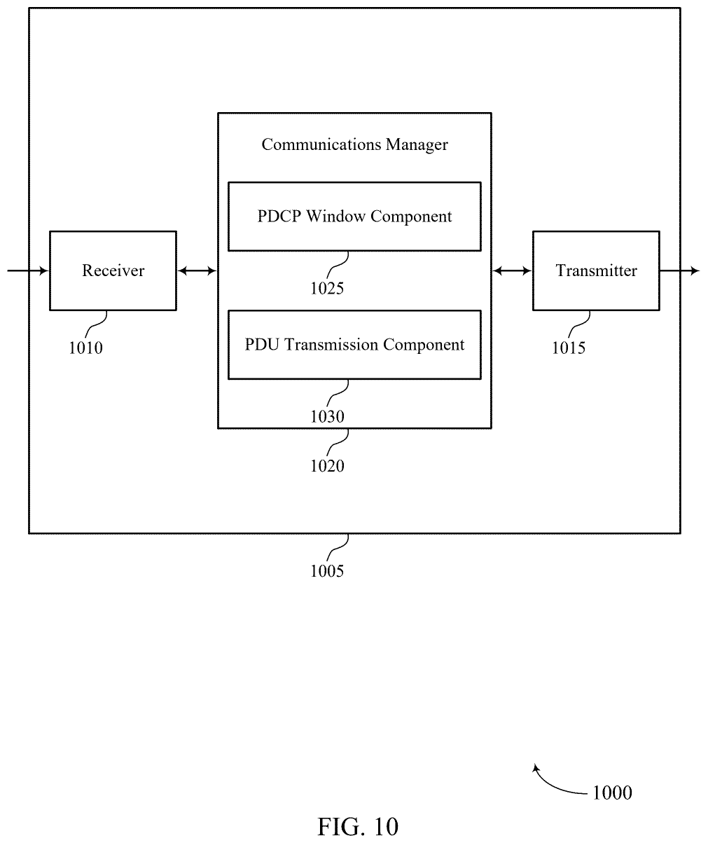

FIG. 10 shows a block diagram 1000 of a device 1005 that supports protocol data unit sequence number synchronization in wireless communications in accordance with one or more aspects of the present disclosure. The device 1005 may be an example of aspects of a device 905 or a network entity 105 as described herein. The device 1005 may include a receiver 1010, a transmitter 1015, and a communications manager 1020. The device 1005, or one of more components of the device 1005 (e.g., the receiver 1010, the transmitter 1015, the communications manager 1020), may include at least one processor, which may be coupled with at least one memory, to support the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The device 1005, or various components thereof, may be an example of means for performing various aspects of protocol data unit sequence number synchronization in wireless communications as described herein. For example, the communications manager 1020 may include a PDCP window component 1025 a PDU transmission component 1030, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. The PDCP window component 1025 is capable of, configured to, or operable to support a means for setting one or more parameters associated with a packet data convergence protocol (PDCP) window for a UE, where the PDCP window indicates a range of sequence numbers that are to be stored at the UE for reordering of received PDCP protocol data units (PDUs). The PDU transmission component 1030 is capable of, configured to, or operable to support a means for transmitting a first PDCP PDU to the UE that includes a set of bits, a first sequence number, and data, where a value of the set of bits indicates the one or more parameters associated with the PDCP window and that the UE is to store the first PDCP PDU in a buffer with one or more other PDCP PDUs based on the first sequence number being within the PDCP window for PDCP PDU reordering.

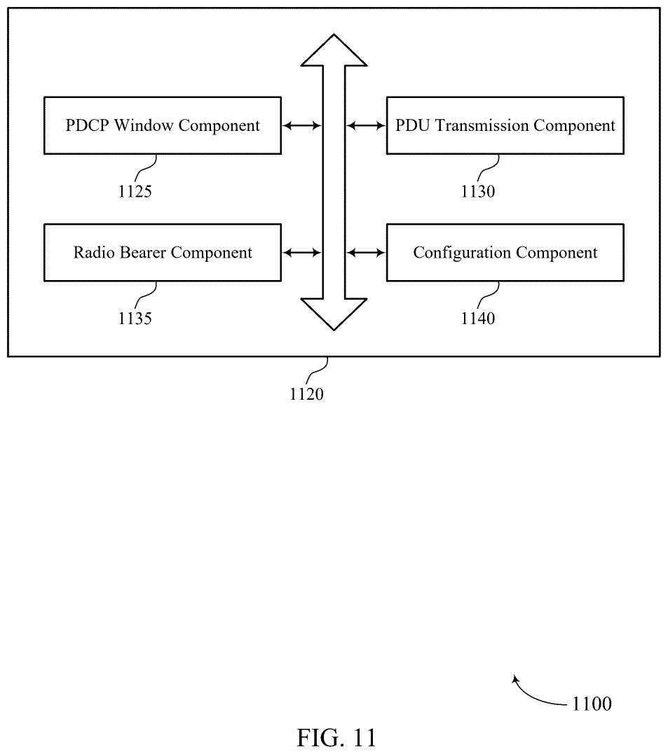

FIG. 11 shows a block diagram 1100 of a communications manager 1120 that supports protocol data unit sequence number synchronization in wireless communications in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of protocol data unit sequence number synchronization in wireless communications as described herein. For example, the communications manager 1120 may include a PDCP window component 1125, a PDU transmission component 1130, a radio bearer component 1135, a configuration component 1140, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1120 may support wireless communications in accordance with examples as disclosed herein. The PDCP window component 1125 is capable of, configured to, or operable to support a means for setting one or more parameters associated with a packet data convergence protocol (PDCP) window for a UE, where the PDCP window indicates a range of sequence numbers that are to be stored at the UE for reordering of received PDCP protocol data units (PDUs). The PDU transmission component 1130 is capable of, configured to, or operable to support a means for transmitting a first PDCP PDU to the UE that includes a set of bits, a first sequence number, and data, where a value of the set of bits indicates the one or more parameters associated with the PDCP window and that the UE is to store the first PDCP PDU in a buffer with one or more other PDCP PDUs based on the first sequence number being within the PDCP window for PDCP PDU reordering.

In some examples, to support setting the one or more parameters associated with the PDCP window, the PDCP window component 1125 is capable of, configured to, or operable to support a means for setting a lower bound of the range of sequence numbers as the first sequence number. In some examples, a first value of the set of bits indicates that the UE is to apply the one or more parameters associated with the PDCP window upon receipt of the set of bits. In some examples, a second value of the set of bits indicates that the UE is to apply the one or more parameters associated with the PDCP window after expiration of a time period. In some examples, the time period corresponds to a duration of a configured timer associated with the set of bits or a portion a duration of a reordering timer associated with the PDCP window. In some examples, the one or more parameters associated with a PDCP window are applied per radio bearer of a set of radio bearers configured at the UE.

In some examples, the one or more parameters associated with the PDCP window are selected from a set of PDCP parameters configured per radio bearer of the set of radio bearers, and where the set of PDCP parameters are indicated by one or more of RRC signaling or a medium access control (MAC) control element. In some examples, the one or more parameters associated with the PDCP window are configured during configuration of each radio bearer, or are based on a service that is associated with each radio bearer. In some examples, the value of the set of bits is based on traffic characteristics associated with the first PDCP PDU. In some examples, the value of the set of bits is based on whether the first PDCP PDU includes data from a first data flow of two or more data flows.

In some examples, the PDCP window component 1125 is capable of, configured to, or operable to support a means for configuring the UE to enable modification one or more parameters associated with the PDCP window based on one or more of an estimated block error rate of communications at the UE, a characteristic of a serving cell of the UE, a type of network used for communications at the UE, or a frequency band used for communications at the UE. In some examples, the set of bits are included in a subset of bits of the PDCP PDU subsequent to a data or control indication bit and prior to the first sequence number in the PDCP PDU.

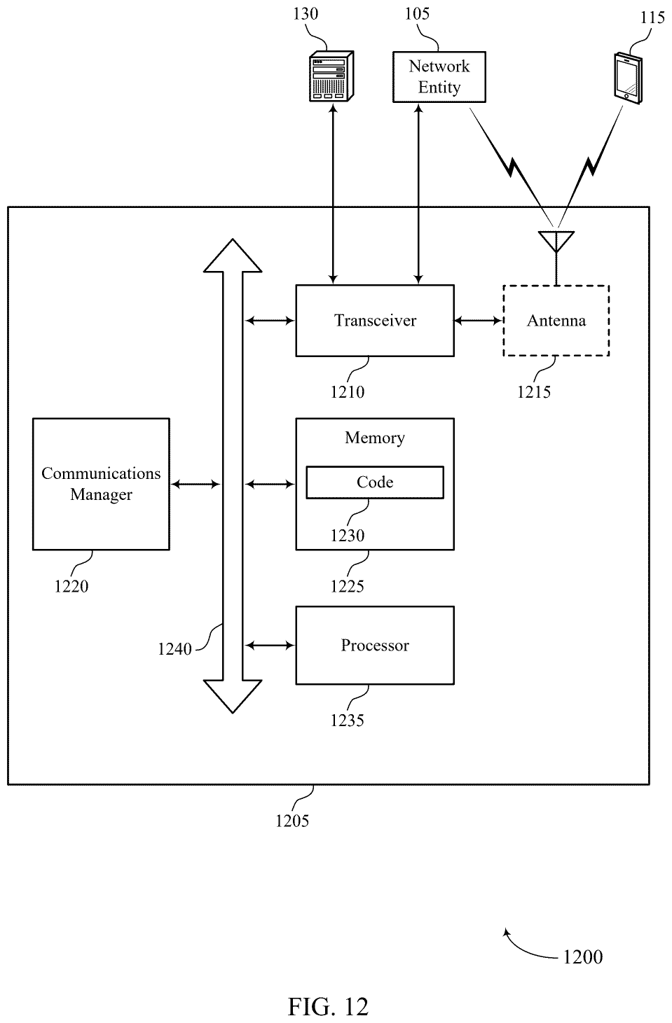

FIG. 12 shows a diagram of a system 1200 including a device 1205 that supports protocol data unit sequence number synchronization in wireless communications in accordance with one or more aspects of the present disclosure. The device 1205 may be an example of or include components of a device 905, a device 1005, or a network entity 105 as described herein. The device 1205 may communicate with other network devices or network equipment such as one or more of the network entities 105, UEs 115, or any combination thereof. The communications may include communications over one or more wired interfaces, over one or more wireless interfaces, or any combination thereof. The device 1205 may include components that support outputting and obtaining communications, such as a communications manager 1220, a transceiver 1210, one or more antennas 1215, at least one memory 1225, code 1230, and at least one processor 1235. These components may be in electronic communication or otherwise coupled (e.g., operatively, communicatively, functionally, electronically, electrically) via one or more buses (e.g., a bus 1240).

The transceiver 1210 may support bi-directional communications via wired links, wireless links, or both as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (e.g., concurrently). The transceiver 1210 may also include a modem to modulate signals, to provide the modulated signals for transmission (e.g., by one or more antennas 1215, by a wired transmitter), to receive modulated signals (e.g., from one or more antennas 1215, from a wired receiver), and to demodulate signals. In some implementations, the transceiver 1210 may include one or more interfaces, such as one or more interfaces coupled with the one or more antennas 1215 that are configured to support various receiving or obtaining operations, or one or more interfaces coupled with the one or more antennas 1215 that are configured to support various transmitting or outputting operations, or a combination thereof. In some implementations, the transceiver 1210 may include or be configured for coupling with one or more processors or one or more memory components that are operable to perform or support operations based on received or obtained information or signals, or to generate information or other signals for transmission or other outputting, or any combination thereof. In some implementations, the transceiver 1210, or the transceiver 1210 and the one or more antennas 1215, or the transceiver 1210 and the one or more antennas 1215 and one or more processors or one or more memory components (e.g., the at least one processor 1235, the at least one memory 1225, or both), may be included in a chip or chip assembly that is installed in the device 1205. In some examples, the transceiver 1210 may be operable to support communications via one or more communications links (e.g., communication link(s) 125, backhaul communication link(s) 120, a midhaul communication link 162, a fronthaul communication link 168).

The at least one memory 1225 may include RAM, ROM, or any combination thereof. The at least one memory 1225 may store computer-readable, computer-executable, or processor-executable code, such as the code 1230. The code 1230 may include instructions that, when executed by one or more of the at least one processor 1235, cause the device 1205 to perform various functions described herein. The code 1230 may be stored in a non-transitory computer-readable medium such as system memory or another type of memory. In some cases, the code 1230 may not be directly executable by a processor of the at least one processor 1235 but may cause a computer (e.g., when compiled and executed) to perform functions described herein. In some cases, the at least one memory 1225 may include, among other things, a BIOS which may control basic hardware or software operation such as the interaction with peripheral components or devices. In some examples, the at least one processor 1235 may include multiple processors and the at least one memory 1225 may include multiple memories. One or more of the multiple processors may be coupled with one or more of the multiple memories which may, individually or collectively, be configured to perform various functions herein (for example, as part of a processing system).

The at least one processor 1235 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1235 may be configured to operate a memory array using a memory controller. In some other cases, a memory controller may be integrated into one or more of the at least one processor 1235. The at least one processor 1235 may be configured to execute computer-readable instructions stored in a memory (e.g., one or more of the at least one memory 1225) to cause the device 1205 to perform various functions (e.g., functions or tasks supporting protocol data unit sequence number synchronization in wireless communications). For example, the device 1205 or a component of the device 1205 may include at least one processor 1235 and at least one memory 1225 coupled with one or more of the at least one processor 1235, the at least one processor 1235 and the at least one memory 1225 configured to perform various functions described herein. The at least one processor 1235 may be an example of a cloud-computing platform (e.g., one or more physical nodes and supporting software such as operating systems, virtual machines, or container instances) that may host the functions (e.g., by executing code 1230) to perform the functions of the device 1205. The at least one processor 1235 may be any one or more suitable processors capable of executing scripts or instructions of one or more software programs stored in the device 1205 (such as within one or more of the at least one memory 1225).

In some examples, the at least one processor 1235 may include multiple processors and the at least one memory 1225 may include multiple memories. One or more of the multiple processors may be coupled with one or more of the multiple memories, which may, individually or collectively, be configured to perform various functions herein. In some examples, the at least one processor 1235 may be a component of a processing system, which may refer to a system (such as a series) of machines, circuitry (including, for example, one or both of processor circuitry (which may include the at least one processor 1235) and memory circuitry (which may include the at least one memory 1225)), or components, that receives or obtains inputs and processes the inputs to produce, generate, or obtain a set of outputs. The processing system may be configured to perform one or more of the functions described herein. For example, the at least one processor 1235 or a processing system including the at least one processor 1235 may be configured to, configurable to, or operable to cause the device 1205 to perform one or more of the functions described herein. Further, as described herein, being “configured to,” being “configurable to,” and being “operable to” may be used interchangeably and may be associated with a capability, when executing code stored in the at least one memory 1225 or otherwise, to perform one or more of the functions described herein.

In some examples, a bus 1240 may support communications of (e.g., within) a protocol layer of a protocol stack. In some examples, a bus 1240 may support communications associated with a logical channel of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1210, the at least one memory 1225, the code 1230, and the at least one processor 1235 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more UEs 115. In some examples, the communications manager 1220 may manage communications with one or more other network entities 105, and may include a controller or scheduler for controlling communications with UEs 115 (e.g., in cooperation with the one or more other network devices). In some examples, the communications manager 1220 may support an X2 interface within an LTE/LTE-A wireless communications network technology to provide communication between network entities 105.

The communications manager 1220 may support wireless communications in accordance with examples as disclosed herein. For example, the communications manager 1220 is capable of, configured to, or operable to support a means for setting one or more parameters associated with a packet data convergence protocol (PDCP) window for a UE, where the PDCP window indicates a range of sequence numbers that are to be stored at the UE for reordering of received PDCP protocol data units (PDUs). The communications manager 1220 is capable of, configured to, or operable to support a means for transmitting a first PDCP PDU to the UE that includes a set of bits, a first sequence number, and data, where a value of the set of bits indicates the one or more parameters associated with the PDCP window and that the UE is to store the first PDCP PDU in a buffer with one or more other PDCP PDUs based on the first sequence number being within the PDCP window for PDCP PDU reordering.

By including or configuring the communications manager 1220 in accordance with examples as described herein, the device 1205 may support techniques for PDCP window reset at a UE that may provide reduced latency for some communications, reduced jitter for delay-sensitive traffic, and improved user experience.

In some examples, the communications manager 1220 may be configured to perform various operations (e.g., receiving, obtaining, monitoring, outputting, transmitting) using or otherwise in cooperation with the transceiver 1210, the one or more antennas 1215 (e.g., where applicable), or any combination thereof. Although the communications manager 1220 is illustrated as a separate component, in some examples, one or more functions described with reference to the communications manager 1220 may be supported by or performed by the transceiver 1210, one or more of the at least one processor 1235, one or more of the at least one memory 1225, the code 1230, or any combination thereof (for example, by a processing system including at least a portion of the at least one processor 1235, the at least one memory 1225, the code 1230, or any combination thereof). For example, the code 1230 may include instructions executable by one or more of the at least one processor 1235 to cause the device 1205 to perform various aspects of protocol data unit sequence number synchronization in wireless communications as described herein, or the at least one processor 1235 and the at least one memory 1225 may be otherwise configured to, individually or collectively, perform or support such operations.

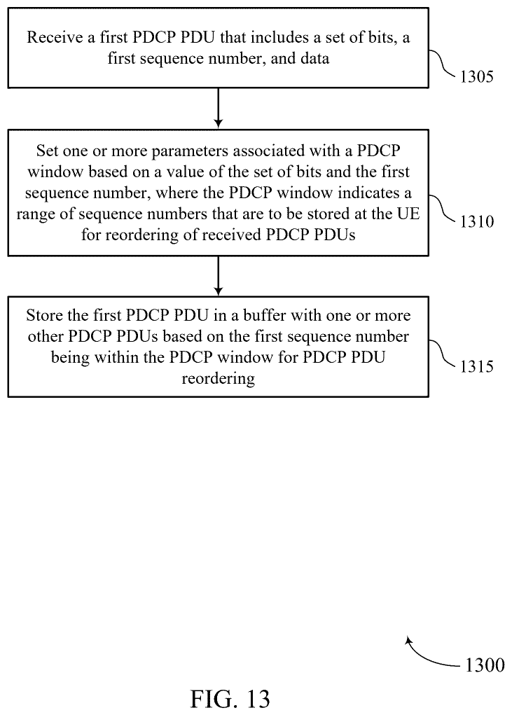

FIG. 13 shows a flowchart illustrating a method 1300 that supports protocol data unit sequence number synchronization in wireless communications in accordance with one or more aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1305, the method may include receiving a first packet data convergence protocol (PDCP) protocol data unit (PDU) that includes a set of bits, a first sequence number, and data. The operations of 1305 may be performed in accordance with examples as disclosed herein. In some examples, aspects of the operations of 1305 may be performed by a PDU reception component 725 as described with reference to FIG. 7.

At 1310, the method may include setting one or more parameters associated with a PDCP window based on a value of the set of bits and the first sequence number, where the PDCP window indicates a range of sequence numbers that are to be stored at the UE for reordering of received PDCP PDUs. The operations of 1310 may be performed in accordance with examples as disclosed herein. In some examples, aspects of the operations of 1310 may be performed by a PDCP window component 730 as described with reference to FIG. 7.

At 1315, the method may include storing the first PDCP PDU in a buffer with one or more other PDCP PDUs based on the first Sequence number being within the PDCP window for PDCP PDU reordering. The operations of 1315 may be performed in accordance with examples as disclosed herein. In some examples, aspects of the operations of 1315 may be performed by a buffer component 735 as described with reference to FIG. 7.

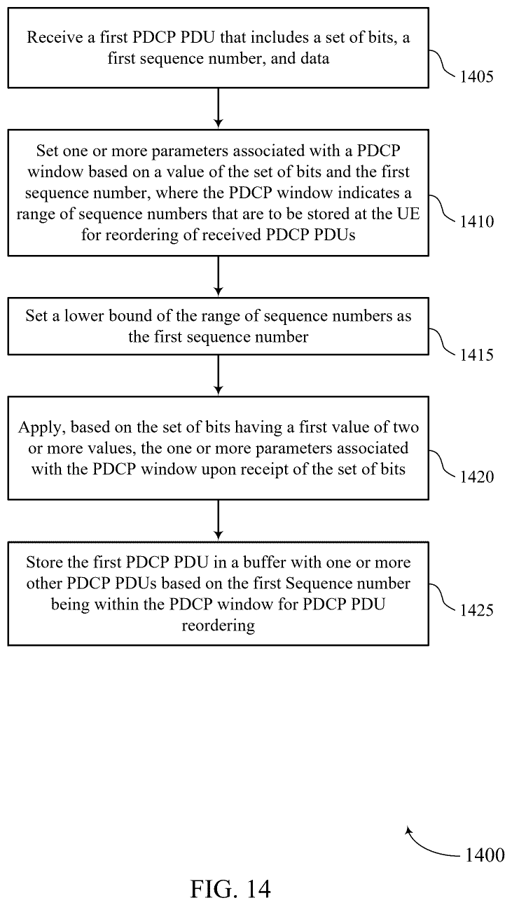

FIG. 14 shows a flowchart illustrating a method 1400 that supports protocol data unit sequence number synchronization in wireless communications in accordance with one or more aspects of the present disclosure. The operations of the method 1400 may be implemented by a UE or its components as described herein. For example, the operations of the method 1400 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1405, the method may include receiving a first packet data convergence protocol (PDCP) protocol data unit (PDU) that includes a set of bits, a first sequence number, and data. The operations of 1405 may be performed in accordance with examples as disclosed herein. In some examples, aspects of the operations of 1405 may be performed by a PDU reception component 725 as described with reference to FIG. 7.

At 1410, the method may include setting one or more parameters associated with a PDCP window based on a value of the set of bits and the first sequence number, where the PDCP window indicates a range of sequence numbers that are to be stored at the UE for reordering of received PDCP PDUs. The operations of 1410 may be performed in accordance with examples as disclosed herein. In some examples, aspects of the operations of 1410 may be performed by a PDCP window component 730 as described with reference to FIG. 7.

At 1415, the method may include setting a lower bound of the range of sequence numbers as the first sequence number. The operations of 1415 may be performed in accordance with examples as disclosed herein. In some examples, aspects of the operations of 1415 may be performed by a PDCP window component 730 as described with reference to FIG. 7.

At 1420, the method may include applying, based on the set of bits having a first value of two or more values, the one or more parameters associated with the PDCP window upon receipt of the set of bits. The operations of 1420 may be performed in accordance with examples as disclosed herein. In some examples, aspects of the operations of 1420 may be performed by a PDCP window component 730 as described with reference to FIG. 7.

At 1425, the method may include storing the first PDCP PDU in a buffer with one or more other PDCP PDUs based on the first Sequence number being within the PDCP window for PDCP PDU reordering. The operations of 1425 may be performed in accordance with examples as disclosed herein. In some examples, aspects of the operations of 1425 may be performed by a buffer component 735 as described with reference to FIG. 7.

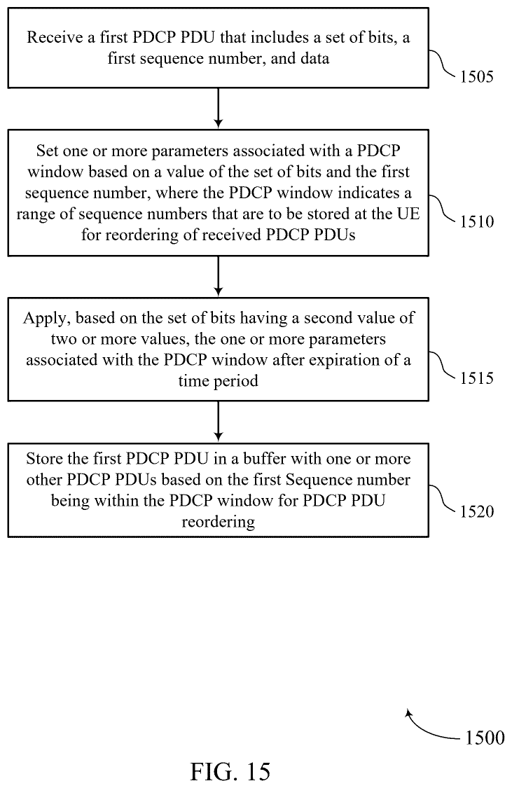

FIG. 15 shows a flowchart illustrating a method 1500 that supports protocol data unit sequence number synchronization in wireless communications in accordance with one or more aspects of the present disclosure. The operations of the method 1500 may be implemented by a UE or its components as described herein. For example, the operations of the method 1500 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1505, the method may include receiving a first packet data convergence protocol (PDCP) protocol data unit (PDU) that includes a set of bits, a first sequence number, and data. The operations of 1505 may be performed in accordance with examples as disclosed herein. In some examples, aspects of the operations of 1505 may be performed by a PDU reception component 725 as described with reference to FIG. 7.

At 1510, the method may include setting one or more parameters associated with a PDCP window based on a value of the set of bits and the first sequence number, where the PDCP window indicates a range of sequence numbers that are to be stored at the UE for reordering of received PDCP PDUs. The operations of 1510 may be performed in accordance with examples as disclosed herein. In some examples, aspects of the operations of 1510 may be performed by a PDCP window component 730 as described with reference to FIG. 7.

At 1515, the method may include applying, based on the set of bits having a second value of two or more values, the one or more parameters associated with the PDCP window after expiration of a time period. The operations of 1515 may be performed in accordance with examples as disclosed herein. In some examples, aspects of the operations of 1515 may be performed by a PDCP window component 730 as described with reference to FIG. 7.

At 1520, the method may include storing the first PDCP PDU in a buffer with one or more other PDCP PDUs based on the first Sequence number being within the PDCP window for PDCP PDU reordering. The operations of 1520 may be performed in accordance with examples as disclosed herein. In some examples, aspects of the operations of 1520 may be performed by a buffer component 735 as described with reference to FIG. 7.

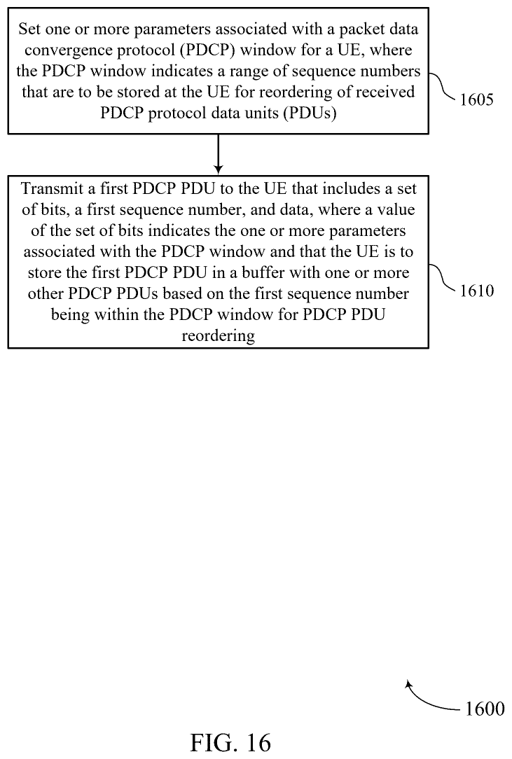

FIG. 16 shows a flowchart illustrating a method 1600 that supports protocol data unit sequence number synchronization in wireless communications in accordance with one or more aspects of the present disclosure. The operations of the method 1600 may be implemented by a network entity or its components as described herein. For example, the operations of the method 1600 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1605, the method may include setting one or more parameters associated with a packet data convergence protocol (PDCP) window for a UE, where the PDCP window indicates a range of sequence numbers that are to be stored at the UE for reordering of received PDCP protocol data units (PDUs). The operations of 1605 may be performed in accordance with examples as disclosed herein. In some examples, aspects of the operations of 1605 may be performed by a PDCP window component 1125 as described with reference to FIG. 11.

At 1610, the method may include transmitting a first PDCP PDU to the UE that includes a set of bits, a first sequence number, and data, where a value of the set of bits indicates the one or more parameters associated with the PDCP window and that the UE is to store the first PDCP PDU in a buffer with one or more other PDCP PDUs based on the first sequence number being within the PDCP window for PDCP PDU reordering. The operations of 1610 may be performed in accordance with examples as disclosed herein. In some examples, aspects of the operations of 1610 may be performed by a PDU transmission component 1130 as described with reference to FIG. 11.

The following provides an overview of aspects of the present disclosure:
Aspect 1: A method for wireless communications at a UE, comprising: receiving a first packet data convergence protocol (PDCP) protocol data unit (PDU) that comprises a set of bits, a first sequence number, and data; setting one or more parameters associated with a PDCP window based at least in part on a value of the set of bits and the first sequence number, wherein the PDCP window indicates a range of sequence numbers that are to be stored at the UE for reordering of received PDCP PDUs; and storing the first PDCP PDU in a buffer with one or more other PDCP PDUs based at least in part on the first Sequence number being within the PDCP window for PDCP PDU reordering.
Aspect 2: The method of aspect 1, wherein setting the one or more parameters associated with the PDCP window comprises: setting a lower bound of the range of sequence numbers as the first sequence number.
Aspect 3: The method of any of aspects 1 through 2, further comprising: applying, based at least in part on the set of bits having a first value of two or more values, the one or more parameters associated with the PDCP window upon receipt of the set of bits.
Aspect 4: The method of any of aspects 1 through 3, further comprising: applying, based at least in part on the set of bits having a second value of two or more values, the one or more parameters associated with the PDCP window after expiration of a time period.
Aspect 5: The method of aspect 4, wherein the time period corresponds to a duration of a configured timer associated with the set of bits or a portion a duration of a reordering timer associated with the PDCP window.
Aspect 6: The method of any of aspects 1 through 5, wherein the one or more parameters associated with a PDCP window are applied per radio bearer of a set of radio bearers configured at the UE.
Aspect 7: The method of aspect 6, wherein the one or more parameters associated with the PDCP window are selected from a set of PDCP parameters configured per radio bearer of the set of radio bearers, and wherein the set of PDCP parameters are indicated by one or more of RRC signaling or a medium access control (MAC) control element.
Aspect 8: The method of any of aspects 6 through 7, wherein the one or more parameters associated with the PDCP window are configured during configuration of each radio bearer, or are based on a service that is associated with each radio bearer.
Aspect 9: The method of any of aspects 1 through 8, wherein the value of the set of bits is based at least in part on traffic characteristics associated with the first PDCP PDU.
Aspect 10: The method of any of aspects 1 through 9, wherein the value of the set of bits is based at least in part on whether the first PDCP PDU includes data from a first data flow of two or more data flows.
Aspect 11: The method of any of aspects 1 through 10, further comprising: enabling the setting of the one or more parameters associated with the PDCP window based at least in part on one or more of an estimated block error rate of communications at the UE, a characteristic of a serving cell of the UE, a type of network used for communications at the UE, or a frequency band used for communications at the UE.
Aspect 12: The method of any of aspects 1 through 11, wherein the set of bits are included in a subset of bits of the PDCP PDU subsequent to a data or control indication bit and prior to the first sequence number in the PDCP PDU.
Aspect 13: A method for wireless communications at a network entity, comprising: setting one or more parameters associated with a packet data convergence protocol (PDCP) window for a UE, wherein the PDCP window indicates a range of sequence numbers that are to be stored at the UE for reordering of received PDCP protocol data units (PDUs); and transmitting a first PDCP PDU to the UE that comprises a set of bits, a first sequence number, and data, wherein a value of the set of bits indicates the one or more parameters associated with the PDCP window and that the UE is to store the first PDCP PDU in a buffer with one or more other PDCP PDUs based at least in part on the first sequence number being within the PDCP window for PDCP PDU reordering.
Aspect 14: The method of aspect 13, wherein setting the one or more parameters associated with the PDCP window comprises: setting a lower bound of the range of sequence numbers as the first sequence number.
Aspect 15: The method of any of aspects 13 through 14, wherein a first value of the set of bits indicates that the UE is to apply the one or more parameters associated with the PDCP window upon receipt of the set of bits.
Aspect 16: The method of any of aspects 13 through 15, wherein a second value of the set of bits indicates that the UE is to apply the one or more parameters associated with the PDCP window after expiration of a time period.
Aspect 17: The method of aspect 16, wherein the time period corresponds to a duration of a configured timer associated with the set of bits or a portion a duration of a reordering timer associated with the PDCP window.
Aspect 18: The method of any of aspects 13 through 17, wherein the one or more parameters associated with a PDCP window are applied per radio bearer of a set of radio bearers configured at the UE.
Aspect 19: The method of aspect 18, wherein the one or more parameters associated with the PDCP window are selected from a set of PDCP parameters configured per radio bearer of the set of radio bearers, and wherein the set of PDCP parameters are indicated by one or more of RRC signaling or a medium access control (MAC) control element.
Aspect 20: The method of any of aspects 18 through 19, wherein the one or more parameters associated with the PDCP window are configured during configuration of each radio bearer, or are based on a service that is associated with each radio bearer.
Aspect 21: The method of any of aspects 13 through 20, wherein the value of the set of bits is based at least in part on traffic characteristics associated with the first PDCP PDU.
Aspect 22: The method of any of aspects 13 through 21, wherein the value of the set of bits is based at least in part on whether the first PDCP PDU includes data from a first data flow of two or more data flows.
Aspect 23: The method of any of aspects 13 through 22, further comprising: configuring the UE to enable modification one or more parameters associated with the PDCP window based at least in part on one or more of an estimated block error rate of communications at the UE, a characteristic of a serving cell of the UE, a type of network used for communications at the UE, or a frequency band used for communications at the UE.
Aspect 24: The method of any of aspects 13 through 23, wherein the set of bits are included in a subset of bits of the PDCP PDU subsequent to a data or control indication bit and prior to the first sequence number in the PDCP PDU.
Aspect 25: A UE for wireless communications, comprising one or more memories storing processor-executable code, and one or more processors coupled with the one or more memories and individually or collectively operable to execute the code to cause the UE to perform a method of any of aspects 1 through 12.
Aspect 26: A UE for wireless communications, comprising at least one means for performing a method of any of aspects 1 through 12.
Aspect 27: A non-transitory computer-readable medium storing code for wireless communications, the code comprising instructions executable by one or more processors to perform a method of any of aspects 1 through 12.
Aspect 28: A network entity for wireless communications, comprising one or more memories storing processor-executable code, and one or more processors coupled with the one or more memories and individually or collectively operable to execute the code to cause the network entity to perform a method of any of aspects 13 through 24.
Aspect 29: A network entity for wireless communications, comprising at least one means for performing a method of any of aspects 13 through 24.
Aspect 30: A non-transitory computer-readable medium storing code for wireless communications, the code comprising instructions executable by one or more processors to perform a method of any of aspects 13 through 24.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive a first packet data convergence protocol (PDCP) protocol data unit (PDU) that comprises a set of bits, a first sequence number, and data;
set one or more parameters associated with a PDCP window based at least in part on a value of the set of bits and the first sequence number, wherein the PDCP window indicates a range of sequence numbers that are to be stored at the UE for reordering of received PDCP PDUs; and
store the first PDCP PDU in a buffer with one or more other PDCP PDUs based at least in part on the first Sequence number being within the PDCP window for PDCP PDU reordering.

2. The UE of claim 1, wherein, to set the one or more parameters associated with the PDCP window, the one or more processors are individually or collectively operable to execute the code to cause the UE to:
set a lower bound of the range of sequence numbers as the first sequence number.

3. The UE of claim 1, wherein the one or more processors are individually or collectively further operable to execute the code to cause the UE to:
apply, based at least in part on the set of bits having a first value of two or more values, the one or more parameters associated with the PDCP window upon receipt of the set of bits.

4. The UE of claim 1, wherein the one or more processors are individually or collectively further operable to execute the code to cause the UE to:
apply, based at least in part on the set of bits having a second value of two or more values, the one or more parameters associated with the PDCP window after expiration of a time period.

5. The UE of claim 4, wherein the time period corresponds to a duration of a configured timer associated with the set of bits or a portion a duration of a reordering timer associated with the PDCP window.

6. The UE of claim 1, wherein the one or more parameters associated with a PDCP window are applied per radio bearer of a set of radio bearers configured at the UE.

7. The UE of claim 6, wherein the one or more parameters associated with the PDCP window are selected from a set of PDCP parameters configured per radio bearer of the set of radio bearers, and wherein the set of PDCP parameters are indicated by one or more of radio resource control (RRC) signaling or a medium access control (MAC) control element.

8. The UE of claim 6, wherein the one or more parameters associated with the PDCP window are configured during configuration of each radio bearer, or are based on a service that is associated with each radio bearer.

9. The UE of claim 1, wherein the value of the set of bits is based at least in part on traffic characteristics associated with the first PDCP PDU.

10. The UE of claim 1, wherein the value of the set of bits is based at least in part on whether the first PDCP PDU includes data from a first data flow of two or more data flows.

11. The UE of claim 1, wherein the one or more processors are individually or collectively further operable to execute the code to cause the UE to:
enable setting of the one or more parameters associated with the PDCP window based at least in part on one or more of an estimated block error rate of communications at the UE, a characteristic of a serving cell of the UE, a type of network used for communications at the UE, or a frequency band used for communications at the UE.

12. The UE of claim 1, wherein the set of bits are included in a subset of bits of the PDCP PDU subsequent to a data or control indication bit and prior to the first sequence number in the PDCP PDU.

13. A network entity, comprising:
one or more memories storing processor-executable code; and
one or more processors coupled with the one or more memories and individually or collectively operable to execute the code to cause the network entity to:
set one or more parameters associated with a packet data convergence protocol (PDCP) window for a user equipment (UE), wherein the PDCP window indicates a range of sequence numbers that are to be stored at the UE for reordering of received PDCP protocol data units (PDUs); and
transmit a first PDCP PDU to the UE that comprises a set of bits, a first sequence number, and data, wherein a value of the set of bits indicates the one or more parameters associated with the PDCP window and that the UE is to store the first PDCP PDU in a buffer with one or more other PDCP PDUs based at least in part on the first sequence number being within the PDCP window for PDCP PDU reordering.

14. The network entity of claim 13, wherein, to set the one or more parameters associated with the PDCP window, the one or more processors are individually or collectively operable to execute the code to cause the network entity to:
set a lower bound of the range of sequence numbers as the first sequence number.

15. The network entity of claim 13, wherein a first value of the set of bits indicates that the UE is to apply the one or more parameters associated with the PDCP window upon receipt of the set of bits.

16. The network entity of claim 13, wherein a second value of the set of bits indicates that the UE is to apply the one or more parameters associated with the PDCP window after expiration of a time period.

17. The network entity of claim 13, wherein the one or more parameters associated with a PDCP window are applied per radio bearer of a set of radio bearers configured at the UE.

18. The network entity of claim 13, wherein the one or more processors are individually or collectively further operable to execute the code to cause the network entity to:
configure the UE to enable modification one or more parameters associated with the PDCP window based at least in part on one or more of an estimated block error rate of communications at the UE, a characteristic of a serving cell of the UE, a type of network used for communications at the UE, or a frequency band used for communications at the UE.

19. A method for wireless communications at a user equipment (UE), comprising:
receiving a first packet data convergence protocol (PDCP) protocol data unit (PDU) that comprises a set of bits, a first sequence number, and data;
setting one or more parameters associated with a PDCP window based at least in part on a value of the set of bits and the first sequence number, wherein the PDCP window indicates a range of sequence numbers that are to be stored at the UE for reordering of received PDCP PDUs; and
storing the first PDCP PDU in a buffer with one or more other PDCP PDUs based at least in part on the first Sequence number being within the PDCP window for PDCP PDU reordering.

20. The method of claim 19, wherein setting the one or more parameters associated with the PDCP window comprises:
setting a lower bound of the range of sequence numbers as the first sequence number.
